(19) United States
(12) Patent Application Publication
(10) Pub. No.: US 2019/0108536 A1
(43) Pub. Date: Apr. 11, 2019

(54) SYSTEM AND METHOD FOR PROVIDING A SOCIAL SEARCH ENGINE, COLLABORATIVE, AND INQUIRY PLATFORM

(71) Applicant: Ali Benamara, Nashua, NH (US)

(72) Inventor: Ali Benamara, Nashua, NH (US)

(21) Appl. No.: 16/152,443

(22) Filed: Oct. 5, 2018

Related U.S. Application Data
(60) Provisional application No. 62/569,096, filed on Oct. 6, 2017.

(51) Int. Cl. G06Q 30/02; G06Q 50/00

(52) U.S. Cl. CPC G06Q 30/0205; G06Q 50/01

(57) ABSTRACT

The present embodiments disclose a social network including a plurality of computing devices in operable communication with a network. The network includes a database configured to store a plurality of user attributes each having at least one identifying characteristic. At least one processor is in operable communication with the plurality of computing devices. The processor is configured to determine the user attributes of each of a plurality of users and categorizing the plurality of users into one or more groups using the at least one identifying characteristics. Information is then provided to the plurality of users dependent on the user attributes.

### CROSS-REFERENCE TO RELATED APPLICATIONS

This application claims priority to U.S. Provisional Application 62/569,096 filed Oct. 6, 2017, entitled “SYSTEM AND METHOD OF A SOCIAL SEARCH ENGINE, COLLABORATIVE AND INQUIRY PLATFORM” which is hereby incorporated by reference.

### TECHNICAL FIELD

The embodiments relate to a system for providing an interactive social search engine platform which categorizes and organizes interactions between users.

### BACKGROUND

Businesses and individuals alike are continually searching for new ways to engage with one another. Through the use of the internet and personal electronic devices, communication has become increasingly streamlined to ensure a vast variety of information is provided to users. However, while the billions of users in communication with a network provide no shortage of information, this information is often not relevant or is not from a reputable source. This success in providing a large amount of information has, however, lead to inaccurate or irrelevant information provided to the community of users.

Current systems do not provide a way for businesses to categorize users based on user attributes. This results in businesses interacting with an irrelevant group of users who do not provide value to their business. Further, the trustworthiness of the user community is not monitored without ensuring the interactive users meet specific user attributes.

### SUMMARY OF THE INVENTION

This summary is provided to introduce a variety of concepts in a simplified form that is further disclosed in the detailed description. This summary is not intended to identify key or essential inventive concepts of the claimed subject matter, nor is it intended for determining the scope of the claimed subject matter.

In one aspect, a social network system includes a plurality of computing devices in operable communication with a network. The network is in communication with one or more users and one or more business users. Further, the network includes a database configured to store a plurality of user attributes. At least one processor is in operable communication with the plurality of computing devices. The processor is configured to determine the user attributes of each of a plurality of users and categorizing the plurality of users into one or more groups using the plurality of user attributes. One or more business users are permitted to select one or more categories to provide a plurality of information to the plurality of users dependent on the category selected by the one or more business users.

In one aspect, the categories can include the user's: username, full name, location, interests, age, and gender.

In one aspect, the system allows for a plurality of requesters to connect with a plurality of connected users based on their current geolocations using GPS or similar location systems to provide an on-demand service. In one example, the live service may include an interview. Users who do not check-in will only be able to view past text, video, and/or audio content.

In another aspect, a system is provided allowing for a plurality of requesters to connect with a plurality of users based on their current group or category for an on-demand service such as a live interview. Users that do not join a group or category will only be able to view past text, video, and audio content.

In another aspect, requesters are permitted to define parameters such as audience sizes, age, and maximum radius to target specific users for live interviews.

In one aspect, a system enables users that meet the predefined parameters of the requesters to be notified of their eligibility to partake in live events.

In one aspect, the system enables users to post questions where a trained artificial intelligence agent can respond in real-time.

In another aspect, enables businesses to create their pages in which they can promote their businesses, sell goods and services, offer support to users, and advertise their goods and services.

In another aspect, the system enables a plurality of users to connect with businesses for live customers service support calls about goods and services.

In one aspect, users can socially connect through live media streams at a landmark location. Businesses local or remote to these landmark locations can use this live stream features to promote their businesses through advertisements.

### BRIEF DESCRIPTION OF THE DRAWINGS

A more complete understanding of the present system and the advantages and features thereof will be more readily understood by reference to the following detailed description when considered in conjunction with the accompanying drawings wherein:

FIG. 1 is a block diagram illustrating the interaction between the components of the system, according to some embodiments;

FIG. 2 is a block diagram illustrating the login or registration of a user or business user through the platform, according to some embodiments;

FIG. 3 is a flowchart illustrating the process of changing or updating the user's profile on the system, according to some embodiments;

FIG. 4 is a flowchart illustrating the process for a business user to set pre-defined parameters for users that the business user wishes to engage within a live interview. Business users who do not set predefined parameters can post an event description that all users can engage with, according to some embodiments;

FIG. 5 is a flowchart illustrating the process for users that meet predefined parameters to search for and be added to the business users waitlist for live events, according to some embodiments;

FIG. 6 is a flowchart illustrating the process for a business user to select a user for an interview from a queue of users, according to some embodiments;

FIG. 7 is a flowchart illustrating the process for a business user to create a new business page on the platform to promote and advertise their goods and services as well as conduct live events and answer customer service requests on the platform, according to some embodiments;

FIG. 8 is a flowchart illustrating the process for a user to start a live customer service inquiry about a product or service with the business user, according to some embodiments;

FIG. 9 is a flowchart illustrating the process for a user to ask a question to a selected audience targeted by a category or geolocation, according to some embodiments;

FIG. 10 is a flowchart illustrating the process for a user to use the social search engine and collaborative features of the platform, according to some embodiments;

FIG. 11 is a flowchart illustrating the process that the platform uses to broadcast live media streams on huge displays at landmark locations, according to some embodiments; and

FIG. 12 is a flowchart illustrating the process that the platform uses to assign and use an index value to give potential buyer-users information about the business user's reputation on the platform, according to some embodiments.

### DETAILED DESCRIPTION

The specific details of the single embodiment or variety of embodiments described herein are to the described system and methods of use. Any specific details of the embodiments are used for demonstration purposes only and not unnecessary limitations or inferences are to be understood therefrom.

Before describing in detail exemplary embodiments, it is noted that the embodiments reside primarily in combinations of components related to the system and method. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The system relates to a social search engine, collaborative, and inquiry platform where a plurality of connected users can interact with each other by asking questions targeted by geolocation, group names, or categories. Users will have to check-in with their geolocation using a global positioning system (GPS) or join a group or category to see live and active events, otherwise, they can only view past text, audio, or video recorded events. Connected users can utilize the platform to search by keywords where other connected users can provide answers, or an artificial intelligence (AI) agent can be trained to provide those answers. Media networks can use this platform to target interviewees, either for free or for a fee, using a category/group or a geolocation with a predefined radius for live video and audio interviews. Businesses can create their pages on this platform where they can promote their businesses, advertise their goods and services, and provide customer service to connected users via text message or live video and audio.

The platform can also be used as a way to connect users by streaming live video feeds from other landmark locations and promoting products, gift cards, and advertisements of businesses.

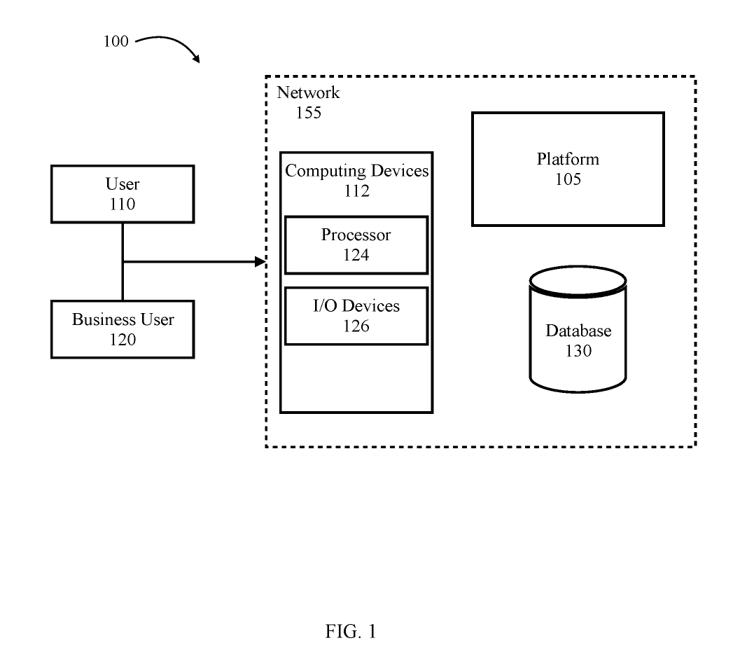

FIG. 1 is a block diagram 100 outlining the interaction of the platform 105 with various users of the system. The platform 105 communicates via the network 155 with the community of users 110,120. As used herein, the term “user” may refer to any person having the capacity to interact with the platform 105 via network 155 which may include users 110, and business users 120. A business user 120 can include representatives of a business who is providing a good or service via the platform 105. The user 110 can include a consumer, or any other non-business-associated user of the platform 105. Each user type 110,120 is in communication with a computing device 112 to engage with a variety of information provided by the community of users to the platform 105.

The computing device 112 includes a processor 124 capable of processing direct user input/output (I/O) interactions. These systems include but are not limited to, desktop computers, laptop computers, personal digital assistants (PDAs), cell phones, tablets, etc. A database 130 is in communication with the network 155 to store user attributes, user settings, and similar data related to the platform 105.

Input and output (I/O) devices 126 in communication with each computing device 112 can include text input devices, audio, and video components, or other commonly used I/O devices used in the arts.

Each computing device 112 can include one or more local storage components include volatile memory and nonvolatile memory. By way of example, and not limitation, nonvolatile memory can include read only memory (ROM), programmable ROM (PROM), electrically programmable ROM (EPROM), electrically erasable programmable ROM (EEPROM), flash memory, or nonvolatile random access memory (RANI) (e.g., ferroelectric RANI (FeRAM). Volatile memory includes random access memory (RAM), which acts as external cache memory. By way of example and not limitation, RANI is available in many forms such as static RANI (SRAM), dynamic RAM (DRAM), synchronous DRAM (SDRAM), double data rate SDRANI (DDR SDRAM), enhanced SDRANI (ESDRAM), Synchlink DRAM (SLDRAM), direct Rambus RAM (DRRAM), direct Rambus dynamic RAM (DRDRAM), and Rambus dynamic RAM.

As used herein, the terms “component,” “system,” “platform,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be but is not limited to being, a process running on a processor, a processor, an object, an executable, a thread of execution, a program, and/or a computer. By way of illustration, both an application running on a server and the server can be a component. One or more components may reside within a process and/or thread of execution, and a component may be localized on one computer and/or distributed between two or more computers.

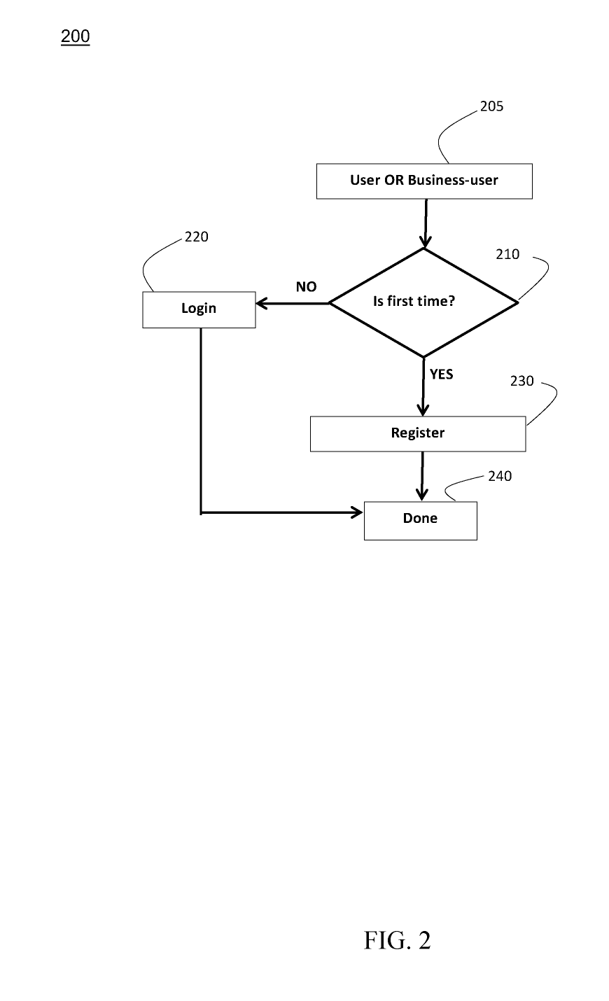

FIG. 2 is a flowchart 200 detailing a login and registration process. According to this process, a determination of the user status as a new business user or user is made in step 205. If the user is a new business user or user (step 210), then the user must undergo a registration process in step 230. If the user is not a new user, then the user may log in to the platform in step 220. After a correct log in through the system, the user is directed to the main screen at step 240. One skilled in the arts will understand various login and registration processes may be implemented.

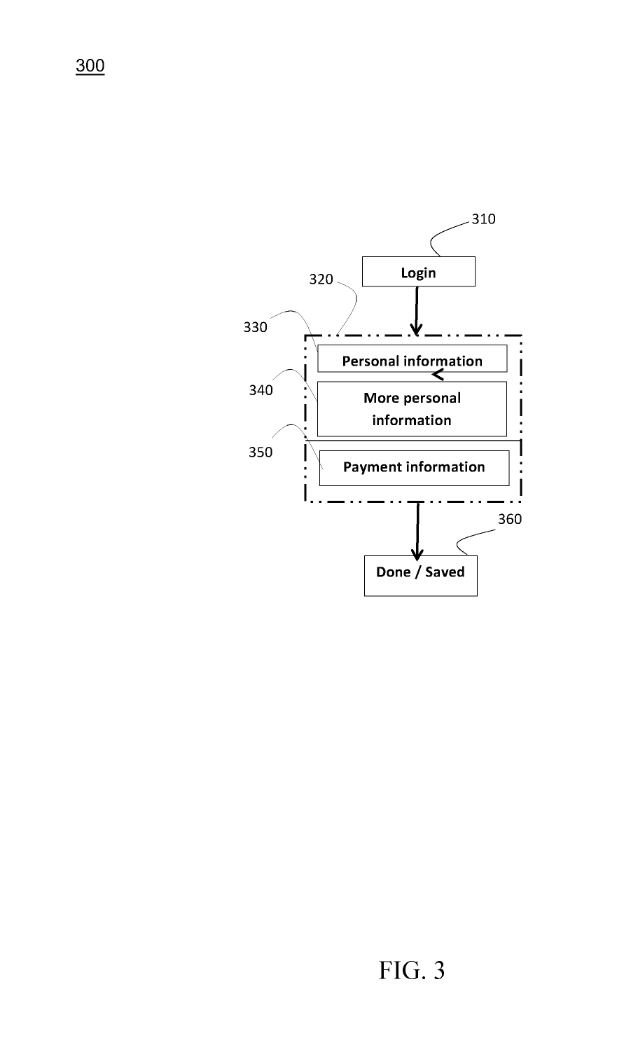

FIG. 3 is a flowchart 300 illustrating the process for making profile changes. The process begins after a user successfully logs in at step 310 indicating whether they are a user 110 or business user 120. The platform 105 has different levels of registration as shown in block 320. At the start, the user 110 can select only to use the free features of the platform and in which case only necessary information will be required during registration, namely block 330 for username and password and block 340 for full name, age, address, and additional personal information. If the user 110 selects to become a business user 120 to sell goods and services or standard user 110 who wants to buy goods and services, then additional information may be required in block 350. After the user makes preferred adjustments to the profile, the changes must be saved to the storage components in block 360.

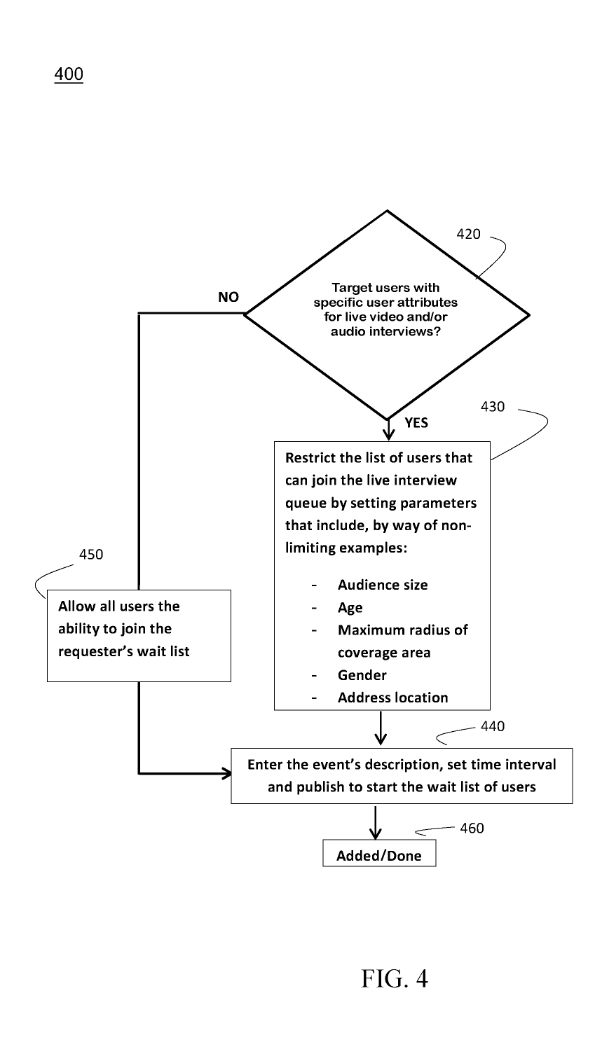

FIG. 4 is a flowchart 400 detailing the process for a business user to set audience parameters and publish a new live event. A business user 120 will first have to login into the platform 105, the platform 105 asks the business user if he or she wants to target users based on specific user attribute parameters in step 420, if the business user 120 selects yes, then the business user 120 selects users 110 on the platform 105 in block 430 by setting user attribute parameters that may include location and address of the event, maximum radius of coverage area, and ages and genders of users that can partake in the live interview. If the business user 120 does not want to target a specific audience, then all other users are allowed to join the live interview as shown in block 450. The selection is then confirmed in block 440 and the business user 120 adds a description of the event, sets a time interval for the duration and the live interview is published on the platform for other participating users to see in block 460.

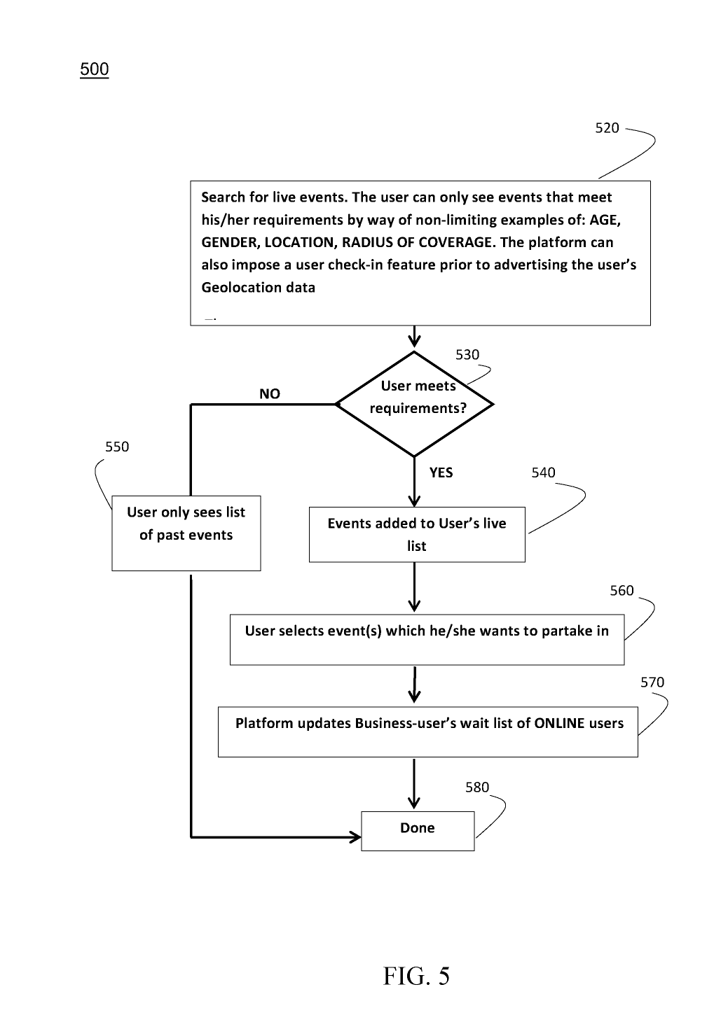

FIG. 5 is a flowchart 500 which details the process for a user 110 to search for live interviews and events. First, the user 110 logs in to the platform, then the user 110 is presented in block 520 with a check-in location button. If pressed, the user's 110 geolocation is sent to the platform, and the user 110 is shown as online on the platform 105. The user 110 can also decide to see live events that meet user attribute parameters including geolocation, age, gender, and categories of interest. If the user 110 meets the requirements in block 530, then all live events will be added to the user's 110 lists on the mobile application in block 540, and he or she can select events to partake in at block 560. In block 570, the business users 120 wait list of active online users 110 meeting the events meeting requirements gets updated and can be selected for the live interview. If the user 110 does not meet the requirements in block 530, then the user can only see a list of past events on the mobile application in block 550. The process is complete in block 580.

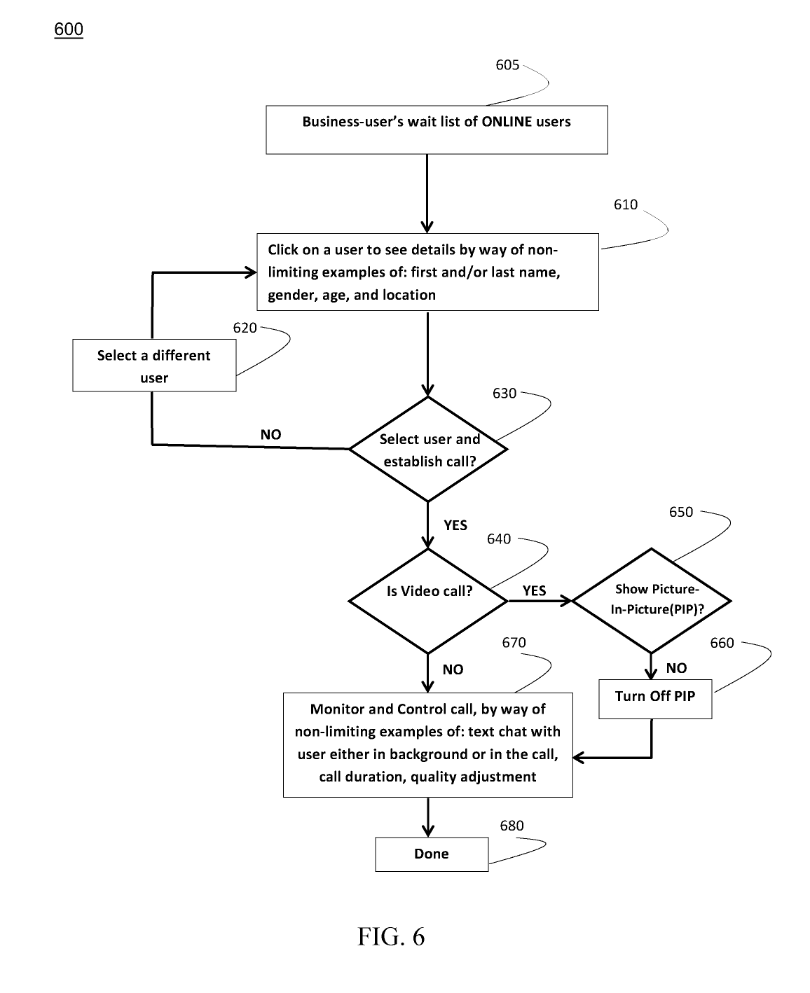

FIG. 6 is a flowchart 600 detailing the process that business user 120 performs to select a user 110 for a live interview. In block 610, the business user 120 can select a user 110 from the waitlist to see user attributes such as names, age, gender, and location of the users. The business user 120 can also scroll to select different users as shown in block 620. If the business user 120 finds the right match for the interview as shown in block 630, then an audio/video call is established in 640 where the picture-in-picture (PIP) feature can be turned on/off if it is a video call as shown in 650, and 660, and monitored in block 670 using verbal or visual communications, call duration, and quality adjustment and finally added to the platform in block 680.

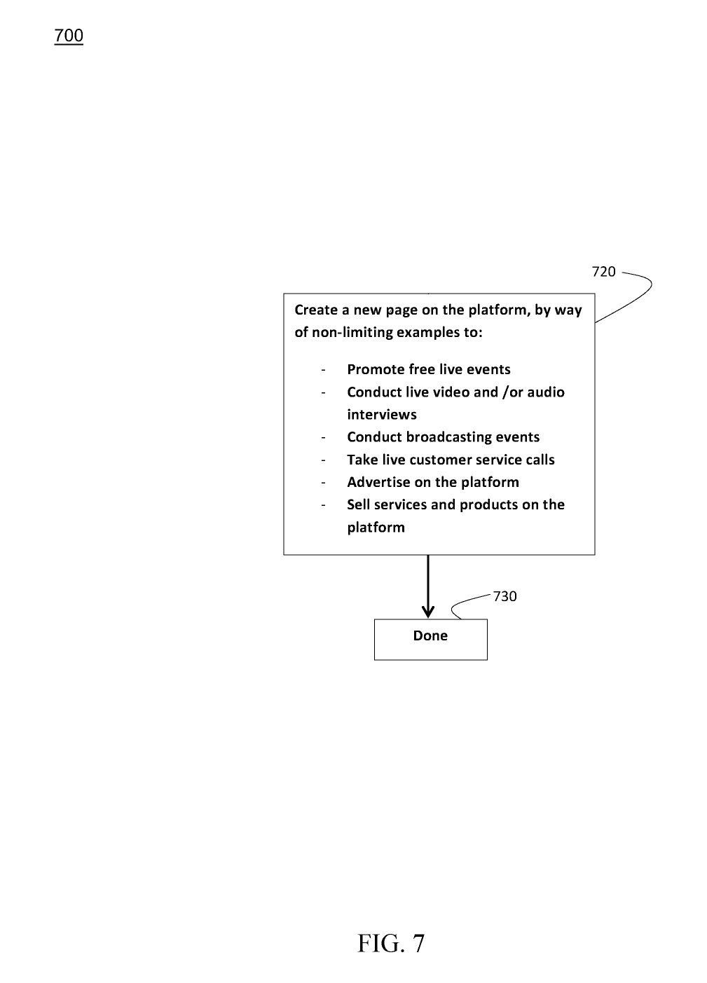

FIG. 7 is a flowchart 700 detailing the process of creating a new business user 120 page on the platform 105. A business user 120 successfully logs and can create a new page on the platform 105 in block 720 and by way of non-limiting example can promote live events, conduct live video and audio interviews based on predetermined user attribute parameters, broadcast live events, engage with audio or visual communication with users 110, generate and provide advertisements, and sell goods and services using the platform 105. Following the creation of content, the page is added to the platform 105 interface in block 730.

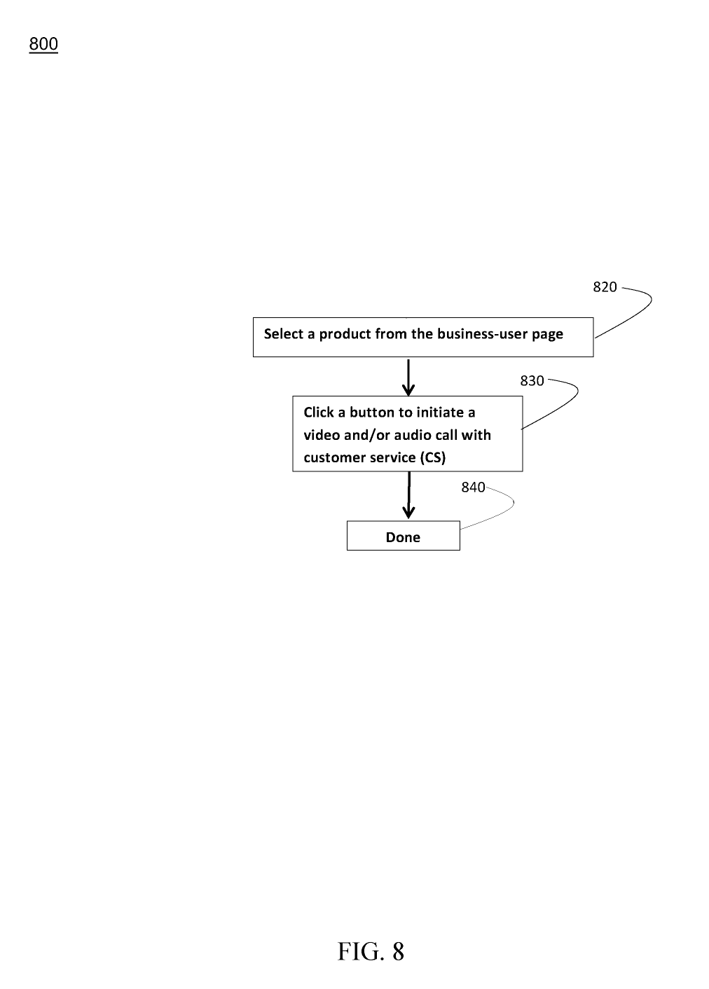

FIG. 8 is a flowchart 800 showing the process by which a user 110 can initiate a customer service call with a business user 120. The user 110 first logs in to the platform 105, then the user 110 selects a product or service from the business users page in block 820. The platform 105 shows in block 830 a button that the user 110 can select to initiate and establish a video and audio call with the business users 120 customer service department. The call gets added to the platform 105 for monitoring in block 840.

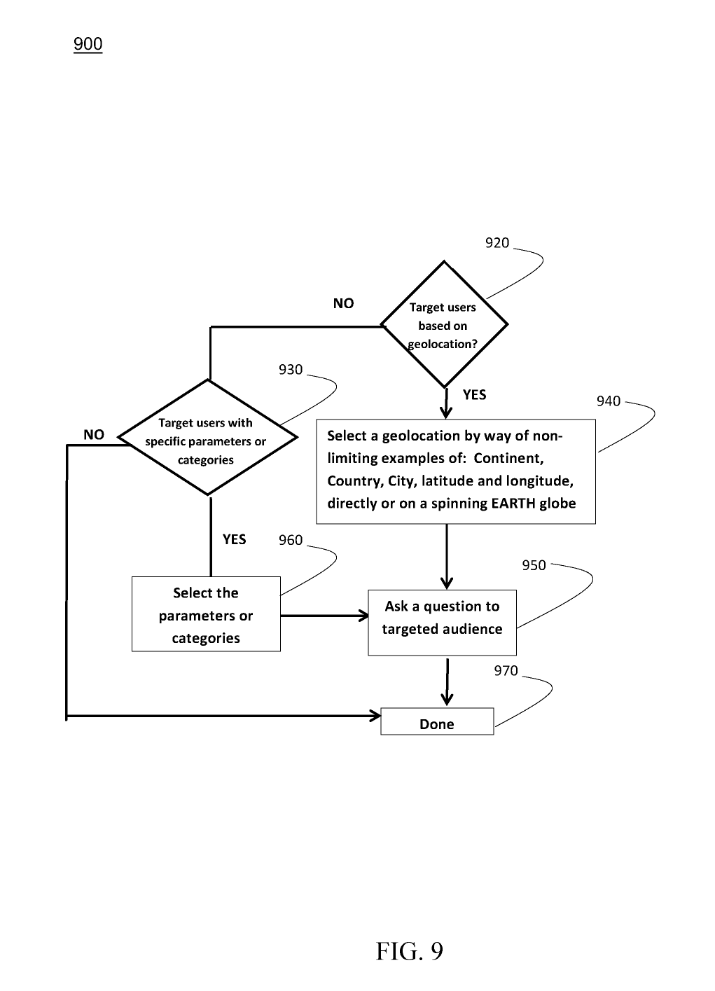

FIG. 9 is a flowchart 900 of the process by which a user 110 or a business user 120 can ask a question to the selected audience. The user 110 first logs in to the platform 105, then select whether to target and the group of users 110 based on geolocation in block 920. If yes, then the user can select a location either directly by providing the latitude, longitude, or by using a spinning earth globe in block 940. Next, the user can ask questions to the selected audience in block 950, while the platform in 970 displays the results. If the user 110 or business user 120 does not want to target by geolocation in block 930, then other parameters including name, categories, age, and gender can be used in block 960, and the user may ask the questions to the selected audience in block 950, and the results would be displayed by the platform 105 in block 970. User attributes including the user's name, location, preferences, or likewise attributes may be utilized.

In one embodiment, as the business user 120 selects from users 110 dependent on user attributes, each selected user can be transferred to a queue. Advertisements, or other forms of media may be displayed to each of the users 110 in the queue for a predetermined period of time prior to the interview or other engagement between the business user(s) 120 and the user(s) 110.

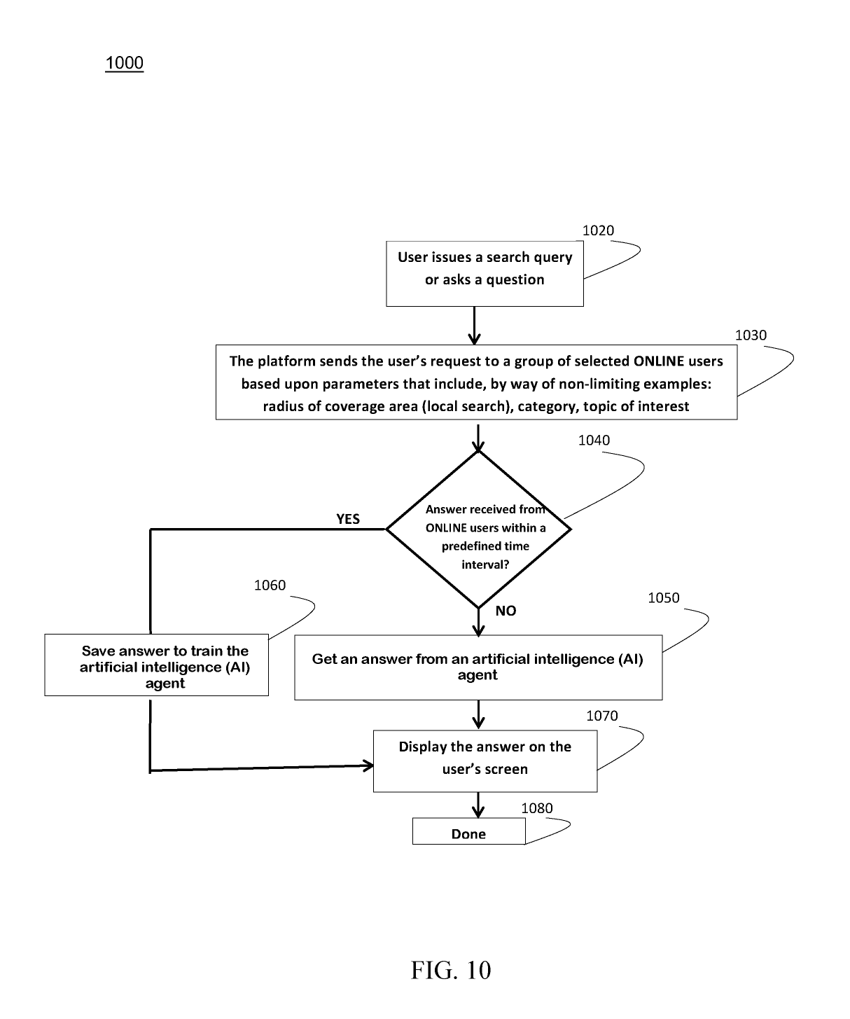

FIG. 10 is a flowchart 1000 showing the process by which a user can use the social search engine feature of the platform 105. The user 110 first logs into the platform 105, then the user 110 issues a search query or asks a question in block 1020. In block 1030, the platform 105 sends the user's 110 requests to a group of selected online users based upon parameters that include radius coverage areas (local search), category, or topic of interest. If an answer is not received in block 1040 within a predefined time interval, then the platform redirects the request to an AI computing system in block 1050 to get the best-matched answer for that request. In step 1070, the platform 105 displays the received answer in block 1040 within the required time interval. The platform 105 adds the answer in block 1060 to the training set of answer used to train the AI computing system and displays it to the user's screen.

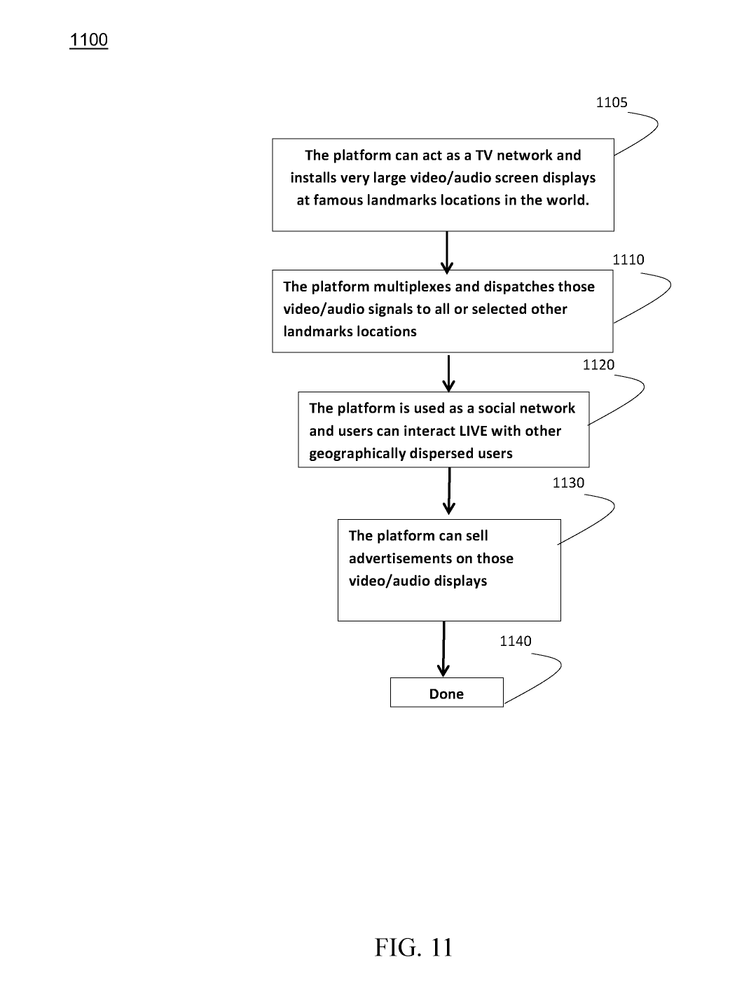

FIG. 11 is a flowchart 1100 showing the process by which the platform displays video and audio streams at landmark locations. In block 1105, the platform can act as a broadcast network. In block 1110, the platform 105 multiplexes and transmits media streams to a predetermined group of locations. Media streams can be used as a social link between users from all other locations as shown in block 1120. Users 110 and business users 120 can interact live with other geographically dispersed users including video screen share, viral videos, and news. The platform 105 also uses those screens in block 1130 to sell advertisements to businesses on the displays.

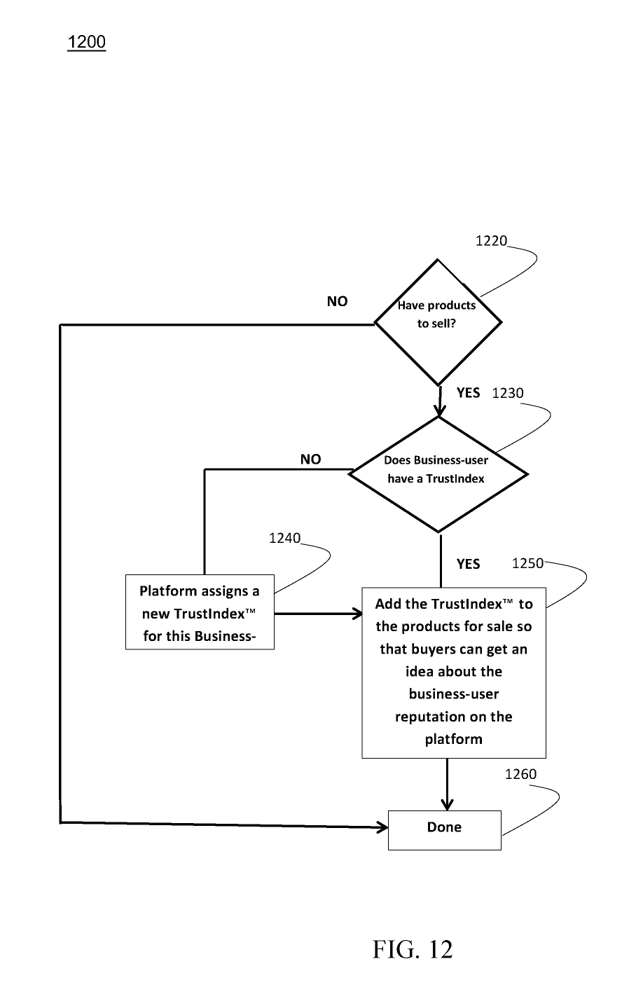

FIG. 12 is a flowchart 1200 showing the process by which the platform uses a rating system to reflect the business reputation on the system. User 110 can rely on the index to comfortably buy goods on the platform. The business user 120 first logs in to the platform 105 if goods or services exist for this business user 120 in block 1220, then the platform 105 determines at block 1230 if a rating already exists for this business user 120. If the rating exists, the platform 105 creates a new starting default rating and assigns to the business user 120 in block 1240. If the rating exists, then the platform 105 in block 1250 determines if the rating needs to be updated before it adds it to the business user 120 goods and services on the users 110 display to alert them about the reputation of the business user 120. The platform ends the process in block 1260.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A social network system comprising:
a plurality of computing devices in operable communication with a network including a database configured to store a plurality of user attributes, the plurality of user attributes to categorize the plurality of users;
at least one processor in operable communication with the plurality of computing devices, the processor configured to perform the following:
determining the user attributes of each of a plurality of users;
categorizing the plurality of users into one or more groups using the plurality of user attributes; and
providing a plurality of information to the plurality of users to a predetermined category.

2. The system of claim 1, wherein the plurality of user attributes includes at least one of the following:
username;
user's full name;
user's location;
user's interests;
user's age; and
user's gender.

3. The system of claim 2, further comprising an AI agent configured to perform the following:
determining user interests; and
monitoring user interactions.

4. The system of claim 2, wherein the user location is determined by a position location system including at least one of: GPS location, spinning earth globe, manual-input location, menu-driven, and location selection.

5. The system of claim 2, further comprising a plurality of business users providing at least one good or at least one service.

6. The system of claim 5, wherein the at least one processor selectively permits the display of the good or service using the plurality of user attributes.

7. The system of claim 2, wherein the plurality of information, at least one good, and at least one service is displayed at a landmark location.

8. The system of claim 2, wherein the plurality of computing devices includes one or more input/output devices operably coupled to the at least one processor, wherein the processor transmits a signal via a server to the database, the signal including text, audio, or video data to be displayed to the plurality of users.

9. The system of claim 8, wherein at least one of the plurality of users engage in an interview with at least one business user.

10. The system of claim 9, wherein the business user selects at least one of the plurality of users to engage in an interview using at least one user attribute.

11. A social network system comprising:
a plurality of computing devices in operable communication with a network in communication with one or more users and one or more business users, the network including a database configured to store a plurality of user attributes;
at least one processor in operable communication with the plurality of computing devices, the processor configured to perform the following:
determining the user attributes of each of a plurality of users; and
categorizing the plurality of users into one or more groups using the at least one identifying characteristics;
permitting the one or more business users to select one or more categories; and
providing a plurality of information to the plurality of users dependent on the category selected by the one or more business users.

12. The system of claim 11, wherein the categories are categorized by at least one of the following:
username;
user's full name;
user's location;
user's interests;
user's age; and
user's gender.

13. The system of claim 12, further comprising an AI agent configured to perform the following:
determining user interests;
monitoring and selectively engaging in user interactions.

14. The system of claim 12, wherein the user location is determined by a position location system including at least one of: GPS location, spinning earth globe, manual-input location, menu-driven, and location selection.

15. The system of claim 12, wherein the plurality of information, at least one good, and at least one service is displayed at a landmark location.

16. The system of claim 12, wherein the plurality of computing devices includes one or more input/output devices operably coupled to the at least one processor, wherein the processor transmits a signal via a server to the database, the signal including text, audio, or video data to be displayed to the plurality of users having predetermined user category.

17. The system of claim 16, wherein the business user and at least one of the plurality of users engage in an interview.

18. The system of claim 9, wherein the business user selects at least one of the plurality of users to engage in an interview using at least one user attribute.

19. A method for providing a user attribute-driven platform accessible over a network in operable communication with a plurality of computing devices in operable communication with a database, the method comprising:
determining, via the processor, one or more user attributes for each of a plurality of users;
storing the one or more user attributes in the database;
selectively associating the plurality of users with one or more categories using the one or more determined user attributes; and
providing, via one or more business users, at least one good or service to at least one of the one or more categories.

20. The method of claim 19, wherein the one or more user attributes includes at least one of the following:
username;
user's full name;
user's location;
user's interests;
user's age; and
user's gender.
